(19) United States
(12) Patent Application Publication
(10) Pub. No.: US 2019/0059611 A1
(43) Pub. Date: Feb. 28, 2019

(54) CHILD SUPPORT DEVICE

(71) Applicant: KIDS II, INC., Atlanta, GA (US)

(72) Inventors: Stephen BURNS, Cumming, GA (US); Chaitanya TADIPATRI, Alpharetta, GA (US); Avelina KAPANZHI, Atlanta, GA (US)

(21) Appl. No.: 16/103,429

(22) Filed: Aug. 14, 2018

Related U.S. Application Data
(60) Provisional application No. 62/549,699, filed on Aug. 24, 2017.

(51) Int. Cl. A47D 13/10; A47D 1/00; A47D 9/02; A47D 15/00; A63H 33/00

(52) U.S. Cl. CPC A47D 13/107; A47D 1/0081; B62B 9/104; A47D 15/008; A63H 33/006; A47D 9/02

(57) ABSTRACT

A child support device includes a support frame having a base portion and an upright portion extending upwardly from the base portion. The upright portion is generally V-shaped and includes an upper junction. A handle is formed with the upper junction to facilitate transporting the child support device and wheels are attached to the base portion to facilitate movement. The arrangement of the support frame allows the support frame to fit through a 30-inch wide door opening. A support arm is pivotally suspended from the upper junction and a child-receiving receptacle is pivotally coupled to the at least one support arm. A capacitive touch control panel adjacent the upper junction controls operation of the child support device in response to user touches. Base and upright portions of the support frame, when viewed from the side, are collectively generally S-shaped.

### CROSS-REFERENCE TO RELATED APPLICATION

This application claims the benefit of U.S. Provisional Patent Application Ser. No. 62/549,699 filed Aug. 24, 2017, the entirety of which is hereby incorporated herein by reference for all purposes.

### TECHNICAL FIELD

The present application is generally directed to child support devices, and more particularly to a child support device with a handle, with a compact frame for fitting through doorways. The support device can be, for example, a swing, rocker, high chair, bouncer, entertainer, or the like.

### BACKGROUND

Child support devices and collapsible child support devices are well known in the art. They typically do not include an easy way to grasp and move the device, and thus, they can be awkward for a caregiver to manually transport from place to place. It is common for the support device to be grasped by a caregiver in such a way that can cause injury or the accidental unfolding or dropping of the device. Thus, there is a need in the art for a support device that is both easy and safe to manually transport. Also, they often can be large and awkward to move through a doorway and often are too wide to be easily moved through the doorway. Thus, there is a need for a support device that is easy to manually transport through a doorway.

It is to the provision of a child support device meeting these and other needs that the present invention is primarily directed.

### SUMMARY

In an example embodiment, the present invention relates to a child support device comprising a support frame including a base portion, an upright portion extending upwardly from the base portion, the upright portion being generally V-shaped and including an upper junction, and a handle formed with or attached to the upper junction to facilitate transporting the child support device. Two or more wheels are attached to the base portion to facilitate movement of the base portion. Preferably, the support frame is narrow enough to fit through a 30-inch wide door opening. At least one support arm is pivotally suspended from the upper junction at a proximal end thereof and a child-receiving receptacle is pivotally coupled to the at least one support arm. A capacitive touch control panel is positioned adjacent the upper junction for controlling operation of the child support device in response to user touches indicating user inputs.

Preferably, the child-receiving receptacle is pivotally coupled to a distal end of the at least one support arm for pivotal movement about a generally vertical axis.

Also preferably, a drive mechanism is provided for driving the movement of the at least one support arm and the child-receiving receptacle with respect to the support frame. Also preferably, the child support device is a swing.

Optionally, the child support device is a swing and the child-receiving receptacle is supported by a single support arm.

Preferably, base and upright portions of the support frame, when viewed from the side, are collectively generally S-shaped.

Preferably, the capacitive touch control panel includes a transparent overlay layer, a sensor layer, and a display layer. Optionally, the capacitive touch control panel includes one or more components manufactured from a flexible substrate, and the capacitive touch control panel is positioned within the upper junction of the support base upright portion. Optionally, the capacitive touch control panel can receive a user input, such as a touch, swipe, or other contact from a finger of a user, from a stylus, or any other object.

According to another aspect of the invention, a child support device includes a support frame with a base portion, and an upright portion extending upwardly from the base portion, with the upright portion being generally V-shaped and including an upper junction. A handle is formed with or attached to the upper junction to facilitate transporting the child support device and two or more wheels attached to the base portion to facilitate movement of the base portion. The support frame is narrow enough to fit through a 30-inch wide door opening and the base and upright portions of the support frame, when viewed from the side, are collectively generally S-shaped. At least one support arm is pivotally suspended from the upper junction at a proximal end thereof. A child-receiving receptacle is pivotally coupled to the at least one support arm.

According to another aspect of the invention, a child support device includes a support frame having a base portion and an upright portion extending upwardly from the base portion. The upright portion is generally V-shaped and includes an upper junction. A handle is formed with the upper junction to facilitate transporting the child support device and wheels are attached to the base portion to facilitate movement. The arrangement of the support frame allows the support frame to fit through a 30-inch wide door opening. A support arm is pivotally suspended from the upper junction and a child-receiving receptacle is pivotally coupled to the at least one support arm.

Preferably, a capacitive touch control panel adjacent the upper junction controls operation of the child support device in response to user touches. Also preferably, base and upright portions of the support frame, when viewed from the side, are collectively generally S-shaped.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a child support device according to an example embodiment of the present invention.

FIG. 2 is a side elevation view of the child support device of FIG. 1.

FIG. 3 is a close-up plan view of a portion of the child support device of FIG. 1.

FIG. 4 is a close-up perspective view of a portion of the child support device of FIG. 1,

FIG. 5 is a front elevation view of the child support device of FIG. 1.

FIG. 6 is an exploded, perspective view of the child support device of FIG. 1.

FIG. 7A is a perspective view of a portion of the child support device of FIG. 1.

FIG. 7B is a close-up, exploded perspective view of the child support device of FIG. 7A.

FIG. 8 is a block diagram of a capacitive touch portion of the child support device according to an embodiment of the present disclosure.

FIG. 9 is a schematic illustration of a capacitive touch portion of the child support device according to an embodiment of the present disclosure.

FIG. 10 is a schematic illustration of a capacitive touch portion of the child support device according to an embodiment of the present disclosure.

FIG. 11 is a schematic diagram of a moving object configured as a pendulum according to an embodiment of the present disclosure.

FIG. 12 is a block diagram of a motion control system including a control device for motion of a moving object according to an embodiment of the present disclosure.

FIG. 13 is a schematic diagram of a motor driving circuit for the motion control system shown in FIG. 12.

FIG. 14 is a schematic view of a motion control system including a magnetic drive system according to an embodiment of the present disclosure.

FIG. 15 is a cross-sectional view of an electromagnetic drive system for a rotatable arm according to an embodiment of the present disclosure.

FIG. 16 is a cross-sectional view of a solenoid drive system for a rotatable arm according to an embodiment of the present disclosure.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

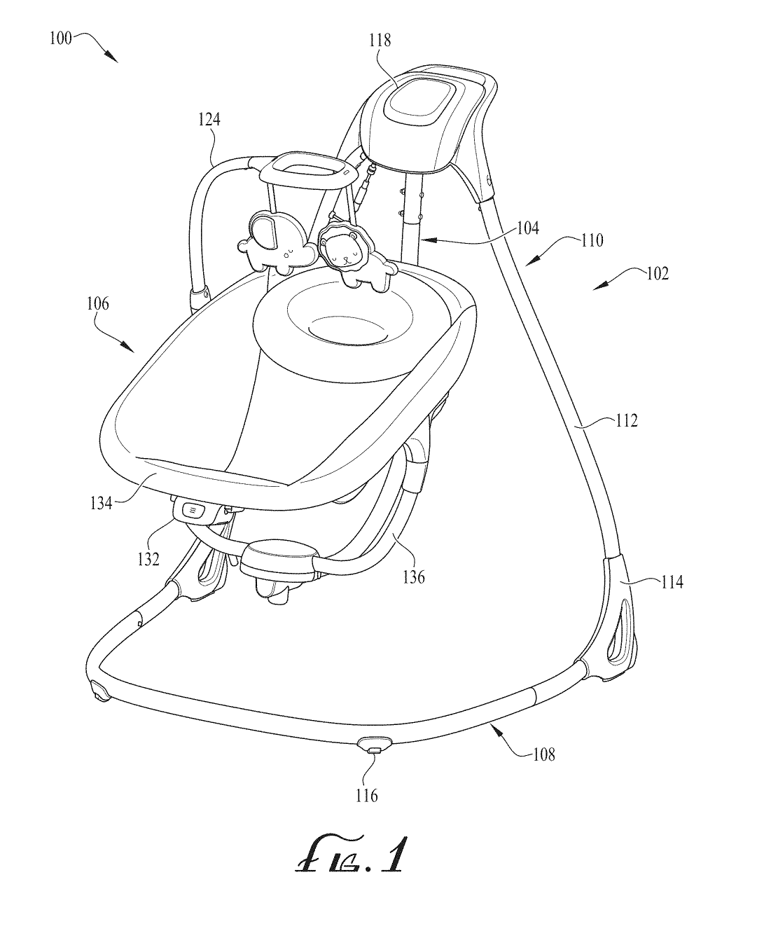

With reference now to the drawing figures, wherein like reference numbers represent corresponding parts throughout the several views, FIGS. 1-4 illustrate an example embodiment of a child support device according to the present invention, wherein the example child support device optionally is a swing 100. The swing 100 generally comprises a swing frame 102, at least one swing arm or support arm 104, and a child-receiving receptacle or swing seat 106. According to the example embodiment, the swing frame 102 comprises a base frame portion 108 configured to rest on a support surface (e.g., a floor) and an upright frame portion 110 coupled to and extending generally upwardly from the base frame portion. The swing arm 104 is rotatably coupled at its first end to the upright frame portion 110 for pivotal movement with respect to the swing frame 102. The swing seat 106 is coupled to the second end of the swing arm 104 at a distance above the support surface and is adapted for receiving a child thereon. Optionally, the swing 100 can be constructed to be convertible between an expanded state, wherein the swing is operable for use, and a collapsed state, wherein the swing is folded for transport or storage.

As shown in the figures, the support frame 102 includes a generally loop-shaped base portion 108, an upright portion 110 extending upwardly from the base portion, the upright portion being generally V-shaped with left and right upright sections 110a and 110b, and including an upper junction or connector hub 118 where the left and right upright sections 110a and 110b come together, and a rear handle 126 formed with or attached to the rear portion of upper junction 118 to facilitate transporting the child support device 100. As shown in FIG. 3, the handle 126 includes a loop 126a defining a hand opening 126b therewithin. Two or more wheels 115 are attached to the base portion 108 to facilitate movement of the base portion. Preferably, the support frame 102 is narrow enough to fit through a 30-inch wide door opening. In the example shown in the figures, the maximum width W is about 28.7 inches. The support arm 104 is pivotally suspended from the upper junction 118 at a proximal end 104a thereof and the child-receiving receptacle 106 is pivotally coupled to the at least one support arm 104 for pivoting motion about a generally upright or vertical pivot axis PA. A capacitive touch control panel 122 is positioned adjacent the upper junction 118 for controlling operation of the child support device 100 in response to user touches indicating user inputs. In the example shown, the capacitive touch control panel 122 is positioned in the upper junction 118.

Preferably, the child-receiving receptacle 106 is pivotally coupled to a distal end 104a of the at least one support arm 104 for pivotal movement about a generally vertical axis PA.

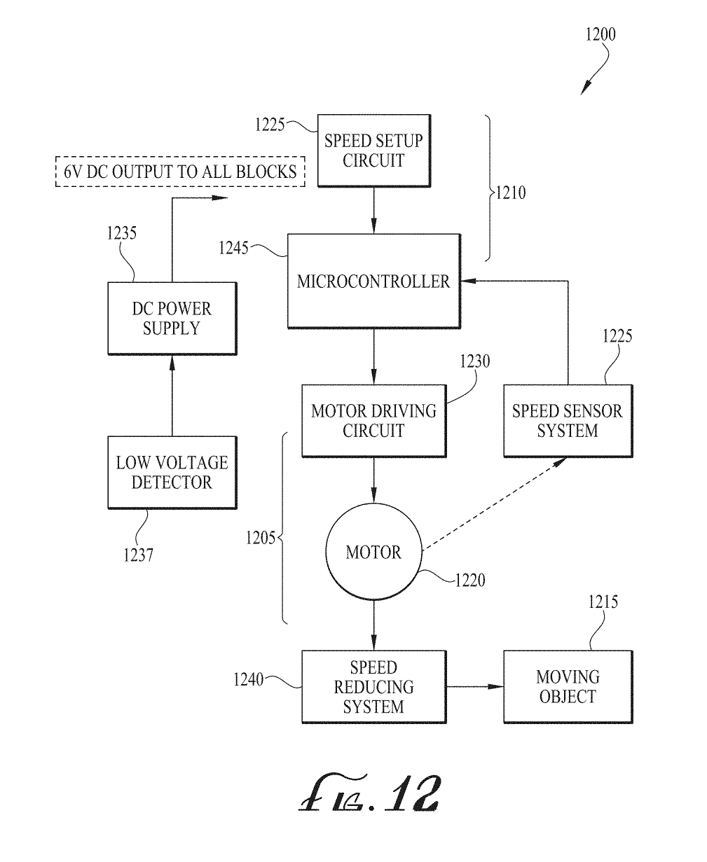

Also preferably, a drive mechanism and/or system 1200 (see FIG. 12) is provided for driving the movement of the at least one support arm 104 and the child-receiving receptacle 106 with respect to the support frame 102. Also preferably, the child support device 100 is a swing.

Preferably, the child support device 100 is a swing and the child-receiving receptacle 106 is supported by a single support arm 104. Preferably, the base 108 and upright portions 110 of the support frame 102, when viewed from the side, are collectively generally S-shaped.

Preferably, the capacitive touch control panel includes a transparent overlay layer, a sensor layer, and a display layer. Optionally, the capacitive touch control panel includes one or more components manufactured from a flexible substrate, and the capacitive touch control panel is positioned within the upper junction of the support base upright portion. Optionally, the capacitive touch control panel can receive a user input, such as a touch, swipe, or other contact from a finger of a user, from a stylus, or any other object.

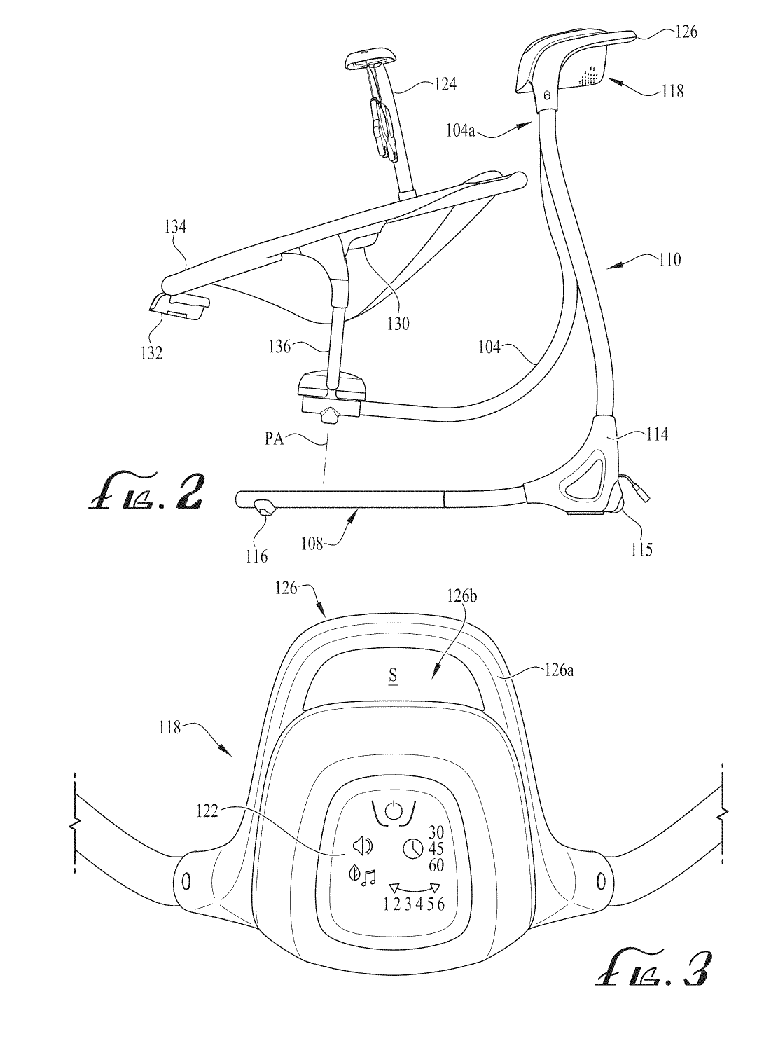

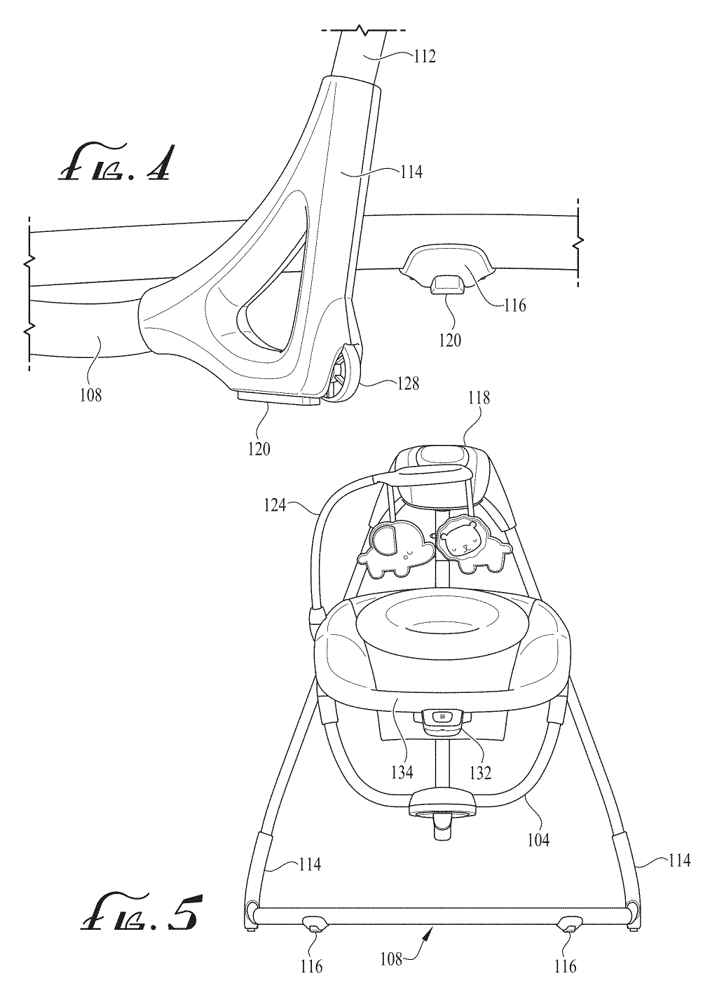

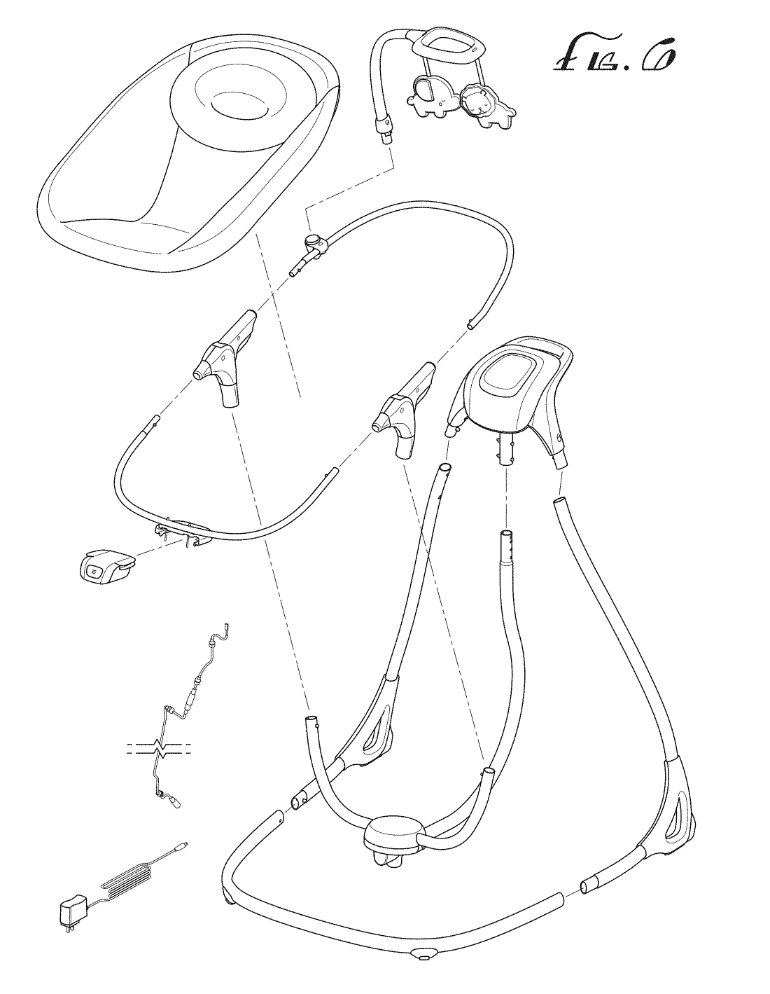

As shown in FIGS. 1 and 2 and especially FIG. 6, the base frame portion 108 includes a generally U-shaped frame member having first and second open ends 108a, 108b. In the depicted embodiment, first and second rear connector feet 114 are coupled to the first and second open ends, respectively, and are adapted to engage the support surface. The base frame portion 108 further includes first and second front feet 116 adapted to engage the support surface. As best shown in FIG. 4, the connector feet 114 and front feet 116 can include slip-resistant pads 120 to prevent unintended sliding of the swing 100 on a support surface.

Referring back now to FIGS. 1 and 2, the upright frame portion 110 includes first and second legs 112 coupled to the first and second rear connector feet 114, respectively, and extending generally upwardly therefrom. As shown, the first and second legs 112 are angled towards each other such that there is less distance between upper ends of the legs than between lower ends. Upper ends of the legs 112 are operatively coupled together by the connector hub 118.

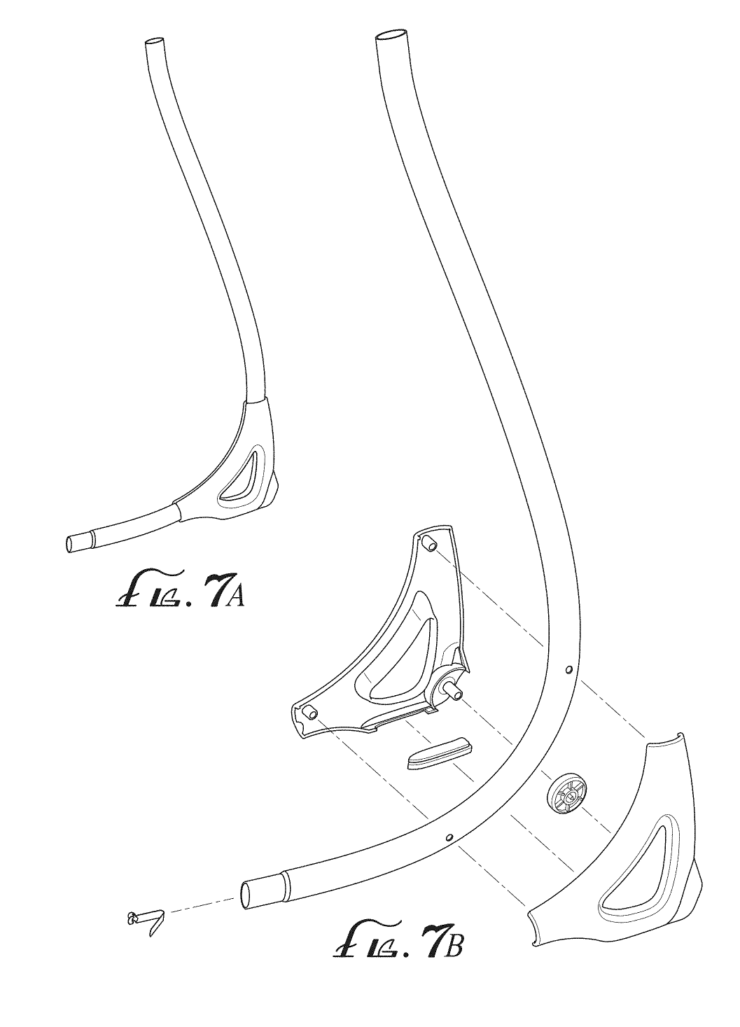

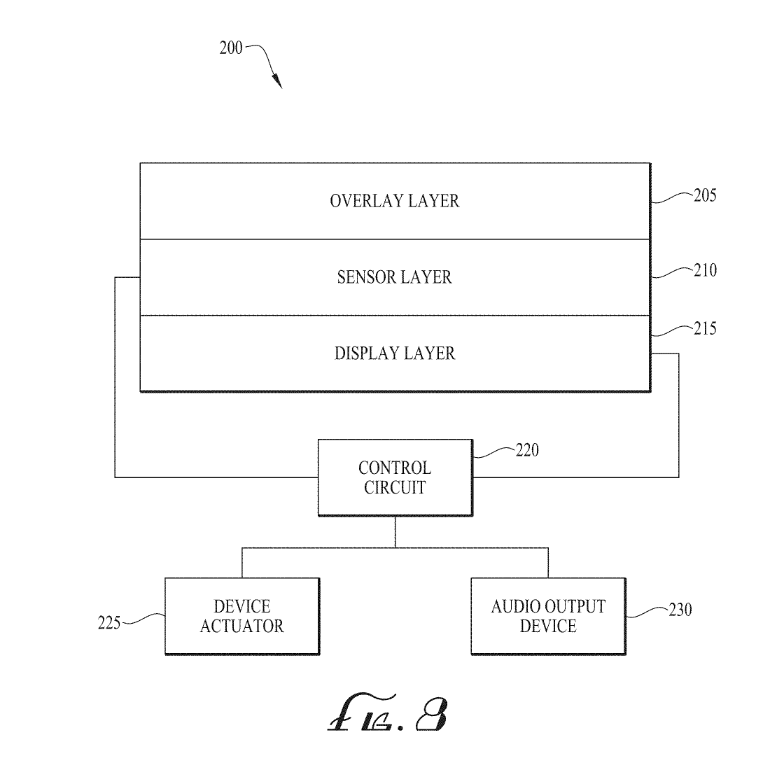

As best seen in FIGS. 7A and 7B, the rear connector feet 114 are themselves two-piece constructions, having two mating halves 114a and 114b that are screwed together with fasteners. The inner mating halve 114b carries an integrally-formed axle 129 which in turn rotatably bears the roller or wheel 128. The rear connector feet 114 also act as couplings to couple the upright legs 112 to the transition tubes or ankles 111. The transition tubes or ankles 111 are connected at their upper ends to the bottoms of the upright legs 112 and are connected at their forward ends to the first and second open ends 108a, 108b of the base frame portion 108.

A child-receiving receptacle, for example, a seat 106, is coupled to the support frame 102 and supported above the support surface by a swing arm 104. The swing arm 104 is connected at a first end to the seat 106 and at a second, opposite end to the connector hub 118. The swing arm 104 is rotatably connected to the connector hub 118 for pivotal movement of the swing arm and the seat 106 with respect to the swing frame 102. The seat 106 comprises a pliable soft goods sling 134 coupled to and suspended from a rigid seat frame 136. The rigid seat frame 136 includes forward or lower hoop 141 and rear or upper hoop 142, T-connectors 143 and 144, and elbows 144, 146. The T-connectors couple the front and rear hoops and support them upon the elbows. The elbows extend out and up from upper hub 147 which is rotatably mounted to lower hub 148 for pivotal or rotational movement about the pivot axis PA (see FIG. 2 for the pivot axis). Collectively, the upper and lower hubs form a rotating or pivoting joint which couples the seat frame to the support arm 104.

Alternative child receiving receptacles can be differently formed; for example, the receptacle may be formed as a more rigid bucket seat made of plastic, rubber, foam, or the like. Further, the child-receiving receptacle can be formed as a generally upright seat, a reclined seat, an inclined sleeper, a generally flat bassinet, or the like. According to the example embodiment depicted herein, the seat 106 is pivotably coupled to the swing arm 104, such that the seat 106 can be selectively positioned in a plurality of seat-facing orientations (e.g., side-facing, front-facing, etc.) Example embodiments of the seat 106 further include a recline adjustment mechanism 130 for selectively adjusting the recline angle of the seat or a portion of the seat, a vibration unit 132 for selectively applying a soothing vibration to the seat, and toy mobile 124 for entertaining a child occupant.

As best shown in FIG. 3, the connector hub 118 comprises a user interface 122 through which a caregiver can control various features of the swing 100. Example features include a drive system for automatically driving the motion of a swing 100 and a sound unit for playing music and/or other sounds. In the depicted embodiment, the user interface 122 can include controls for turning the swing on and off, adjusting the speed or amplitude of the swing, setting a desired length of time for the swing to run, selecting preferred sounds or music, and adjusting the volume of the sounds or music. Example embodiments can include additional swing features controllable by the user interface 122.

The connector hub 118 further comprises a handle 126 for facilitating transport of the swing 100 by a caregiver. The handle 126 can be integrally formed with the connector hub 118, as shown, or can be formed as a separate component. As shown, the handle 126 defines an open space S through which the hand of caregiver can pass, allowing the caregiver to wrap their hand around and fully grip the handle. In the depicted example embodiment, the handle 126 is located on the rear portion of the connector hub 118 and extends away from the swing 100 to allow for easy access from behind the swing. In alternative embodiments, the handle 126 can be located elsewhere on the connector hub 118.

Referring to FIG. 4, each of the first and second connector feet 114 include a wheel 128. When the swing 100 is in the upright, in-use orientation, as shown in FIGS. 1 and 2, the non-resistant slip pads 120 are in contact with the support surface and the wheel 128 is elevated a distance above the support surface. To transport the swing 100 across the support surface, a user can grip the handle 126 and lean the swing backwards, such that the slip pads 120 disengage the support surface and the wheels 128 engage the support surface. A user can then pull or push on the handle 126 to roll the swing 100 across the support surface. In example embodiment, the handle 126 can also serve as a carrying handle to facilitate a user lifting the swing 100.

Various changes and modifications to such a child's support device, beyond those explicitly mentioned herein, are contemplated as being within the scope of the present invention. Notably, the support device can take the form of any known child support device, including a swing, bouncer, high chair, booster, entertainer, play yard, rocker, etc. Additionally, the handle can be formed as a traditional handle, as shown, as a pocket-style handle, or as any other structure suitable for gripping. Moreover, the particular configurations, suggested materials of construction, and objectives described herein are merely exemplary and are in no way limiting.

In some embodiments, the devices described may include a capacitive touch device 1300 as shown in FIG. 8. The capacitive touch device 1300 includes an overlay layer 405, a sensor layer 410, and a display layer 415. One or more of the overlay layer 405, sensor layer 410, and display layer 415 can be manufactured from a flexible substrate, enabling the capacitive touch device 1300 to be installed in various arrangements tailored to the shape of the device in which the capacitive touch device 1300 is implemented.

The overlay layer 405 may receive a user input (e.g., a touch, swipe, or other contact from a finger of a user, from a stylus, or any other object). The overlay layer 405 can be transparent. The overlay layer 405 can include glass, plastic, or other transparent (or partially transparent) materials, which may have a rigidity sufficient to protect the underlying sensor layer 410 and display layer 415 from damage due to repeated use cycles.

The sensor layer 410 can generate a sensor signal based on the user input. The sensor signal can include an indication of a location at which the user input was received by the overlay layer 405. The sensor signal can correspond to a change in capacitance of the sensor layer 410 (or electrical components thereof) resulting from the user input. The sensor layer 410 can generate the sensor signal based on capacitive coupling between the object contacting the overlay layer 405 and the sensor layer 410. The sensor layer 410 can generate the sensor signal using surface capacitance or projected capacitance. The sensor layer 410 can include a conductor (e.g., indium tinoxide (ITO)) which acts as a capacitive layer. The sensor layer 410 can include a plurality of capacitive layers (which may be separated by corresponding insulating layers). The sensor layer 410 can include a transparent substrate to allow light outputted by the display layer 415 to be transmitted through the sensor layer 410 into the overlay layer 405.

The display layer 415 display images to be outputted through the sensor layer 410 and overlay layer 405 for viewing by a user. The sensor layer 410 can be patterned on or placed over the display layer 415. The display layer 415 can include a display device such as a liquid crystal display (LCD), light emitting diode display (LED), organic light emitting diode display (OLED), or any other display device.

In some embodiments, the capacitive touch device 1300 includes a control circuit 1220. The control circuit 1220 can include a processor and memory. The processor may be implemented as a specific purpose processor, an application specific integrated circuit (ASIC), one or more field programmable gate arrays (FPGAs), a group of processing components, or other suitable electronic processing components. The memory is one or more devices (e.g., RAM, ROM, flash memory, hard disk storage) for storing data and computer code for completing and facilitating the various user or client processes, layers, and modules described in the present disclosure. The memory may be or include volatile memory or non-volatile memory and may include database components, object code components, script components, or any other type of information structure for supporting the various activities and information structures of the inventive concepts disclosed herein. The memory is communicably connected to the processor and includes computer code or instruction modules for executing one or more processes described herein. The memory includes various circuits, software engines, and/or modules that cause the processor to execute the systems and methods described herein, including controlling operation of the display layer 415 and a device actuator 425.

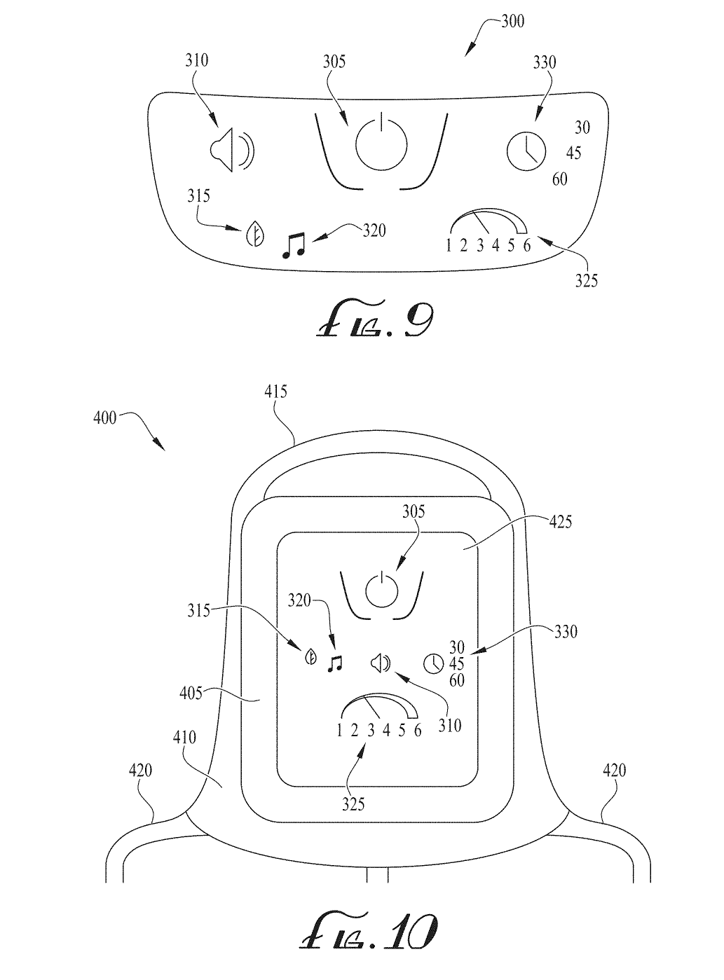

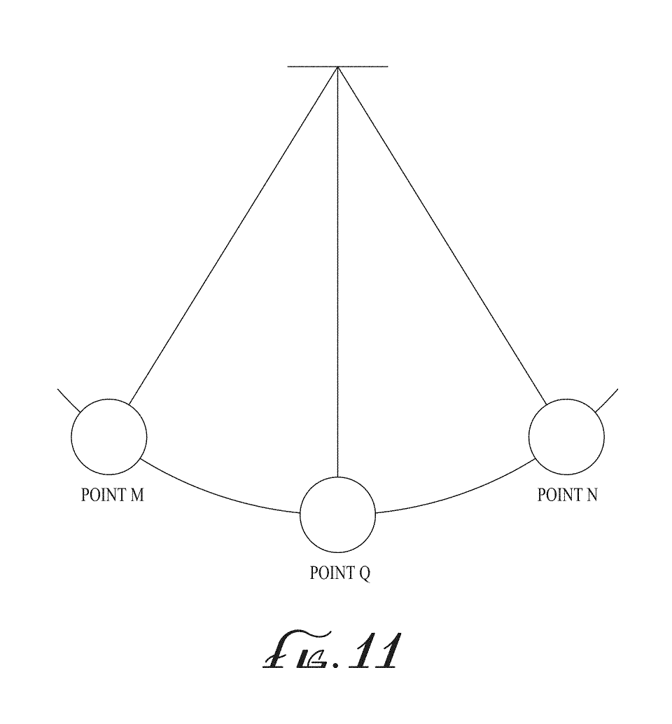

The control circuit 1220 can control operation of the display layer 415. For example, the control circuit 1220 can output a display signal to the display layer 415 to display image(s) based on the display signal. The control circuit 1220 can include a display database including the images to be displayed by the display layer 415. The control circuit 1220 can receive the images to be displayed from a remote source (e.g., via communications electronics, not shown). As will be described further herein with reference to FIGS. 9 and 10, the control circuit 1220 can cause the display layer 415 to display icons, animations, or other visual indicators corresponding to commands to be received by the capacitive touch device 1300.

In some embodiments, the control circuit 1220 receives the sensor signal from the sensor layer 410. The control circuit 1220 can extract a location of the user input from the sensor signal. For example, the sensor signal may include the location of the user input (e.g., a two-dimensional coordinate location corresponding to the surface of the overlay layer 405). The control circuit 1220 can determine the location of the user input based on the sensor signal; for example, the sensor signal may include one or more voltage values which the control circuit 1220 can use to retrieve the location of the user input from a database (e.g., lookup table stored in a database) mapping voltage values to user input locations.

The control circuit 1220 can determine a command indicated by the user input based on the location of the user input. For example, control circuit 1220 can perform a lookup in a command database based on the location of the user input to determine the command. In some embodiments, the command database may correspond to the images of the display database. For example, the control circuit 1220 can reconfigure the command database in response to changes to the display database (or images stored therein), so that the control circuit 1220 can dynamically manage user inputs received even as the arrangement of the image displayed by the display device 415 change. As such, the control circuit 1220 can determine which visual indicator (e.g., icon) displayed by the display device 415 was selected based on the user input.

The control circuit 1220 can control operation of the display layer 415 based on the command. For example, the control circuit 1220 can determine that the command indicates instructions to modify an image displayed by the display layer 415, and in response, modify the display signal based on the command. The control circuit 1220 can determine that the command indicates instructions to modify operational parameters of the display layer 415. The operational parameters may include a power state, such as on, off, or sleep mode. The operational parameters may include a display brightness (which may include a sleep state which is relatively dim compared to a normal operational state).

The control circuit 220 can control operation of an audio output device 230 based on the command. For example, the control circuit 220 can control an operational state of the audio output device 230 (e.g., on, off, volume level). The control circuit 1220 can retrieve an audio file from an audio database based on the command, and cause the audio output device 230 to play the audio file.

In some embodiments, the control circuit 220 controls operation of a device actuator 225 based on the command. The device actuator 225 can include a motor or other drive mechanism for controlling movement of a movable member (e.g., swing arm, door). The control circuit 220 can control parameters of movement of the movable member (e.g., speed, direction, duration) using the device actuator 225.

Referring now to FIG. 9, one embodiment of a capacitive touch device 300 is shown. The capacitive touch device 300 can incorporate features of the capacitive touch device 200 described with reference to FIG. 8.

As shown in the depicted embodiment, the capacitive touch device 300 can display one or more visual indicators (e.g., icons, display elements), which can be associated with commands that the capacitive touch device 300 can execute based on receiving user inputs located at or near the visual indicators. The capacitive touch device 300 can receive a user input corresponding to a selection of a visual indicator. The capacitive touch device 300 can identify a location of the user input, and determine the selection of the visual indicator based on the location of the user input. The capacitive touch device 300 can determine a command corresponding to the visual indicator. For example, the capacitive touch device 300 can determine a command to control movement of a moveable member of the devices described herein, such as a swing arm, and control operation of the swing arm based on the command (e.g., using device actuator 225 of FIG. 8).

As shown in FIG. 9, the capacitive touch device 300 can include various visual indicators including one or more of a power indicator 305, a volume indicator 310, an energy efficiency indicator 315, an audio indicator 320, a speed indicator 325, and a time indicator 330. The capacitive touch device 300 can receive user inputs as touches located on or near the visual indicators, where the user inputs correspond to actions associated with the visual indicators.

The power indicator 305 can indicate a power state of an apparatus incorporating or in communication with the capacitive touch device 300 (e.g., on state, off state, sleep state). The capacitive touch device 300 can receive a user input at the power indicator 305 and modify the power state based on the user input (e.g., change between on, off, and/or sleep states).

The volume indicator 310 can indicate a volume level of an audio output device in communication with the capacitive touch device 300. The capacitive touch device 300 can receive a user input at the volume indicator 310 and modify a volume level of the audio output device based on the user input (e.g., increase volume, decrease volume, mute),

The energy efficiency indicator 315 can indicate whether the capacitive touch device 300 (or an apparatus incorporating the capacitive touch device 300) is operating in an energy efficient state (e.g., the apparatus may include a regenerative braking mechanism, which can recharge a power source, such as a battery, based on motion of a movable member). The capacitive touch device 300 can receive a user input at the energy efficiency indicator 315 and modify an energy efficiency state based on the user input (e.g., activate or deactivate regenerative braking; switch to sleep state).

The audio indicator 320 can indicate whether audio is being played. The capacitive touch device 300 can receive a user input at the audio indicator 320 and modify audio play based on the user input (e.g., turn audio output on or off; select and/or change audio being played).

The speed indicator 325 can indicate a current speed value (e.g., absolute speed or relative speed), or a gear state associated with movement of a movable member, such as a swing arm, wall, gate, or play surface. The capacitive touch device 300 can receive a user input at the speed indicator 325 and modify the current speed value or gear state based on the user input.

The time indicator 330 can indicate a duration of time for which the movable member is to be in motion. The capacitive touch device 300 can receive a user input at the time indicator 330 and modify operation the duration of time based on the user input.

Referring now to FIG. 10, a movement device is shown according to an embodiment of the present disclosure. The movement device 400 can incorporate features of the capacitive touch devices 200, 300 described with reference to FIGS. 8 and 9, respectively. As shown in FIG. 10, the movement device 300 includes a display member 405. A capacitive touch device 425 is attached to the display member 405. The movement device 400 includes a base 410 to which the display member 405 can be attached to or extend from. In some embodiments, the base 410 includes a handle member 415. The base 410 may also include one or more arms 420 extending from the base 410. The arm(s) 420 can be (or be coupled to) movable members that can be moved based on a user input received by the capacitive touch device 425. The capacitive touch device 425 can display one or more visual indicators 305, 310, 315, 320, 325, 330, and receive user inputs corresponding to the one or more visual indicators.

In some embodiments, a drive mechanism can be provided to induce motion (e.g., induce pendulum-type motion in a rotatable arm, such as the pendulum as shown in FIG. 11. The pendulum in FIG. 11 travels in an arc (the figure is schematic and the actual arc depicted may not be a true radius arc). Points M and N on the arc represent the highest positions, at which points a speed of the pendulum is at a minimum. Point Q represents a point at which the pendulum is perpendicular with a line of the ground; at point 0, the speed of the pendulum is at a maximum. In some embodiments, the systems described herein can be used to control a speed of rotation of the rotatable arm. For example, a programmable controller (e.g., control circuit) can receive a signal indicating at least one of a rotation speed or an angular position, and control operation of a motor (e.g., control rotation speed and/or rotation direction) based on the signal, such as to provide a more smooth transition from zero speed (e.g., at points M and N) to maximum speed (e.g., at point 0) or vice versa. The control circuit can be configured to cause the motor to rotate in a reverse direction as a distance between the rotatable arm and point M or point N becomes less than a threshold distance, which may make the transition to the zero speed point more smooth (e.g., more linear). Similarly the control circuit can be configured to cause the motor to rotate at a lesser rotation speed as a distance between the rotatable arm and point Q becomes less than a threshold distance, which may make the transition to a maximum speed at point Q more smooth (e.g., more linear). In some embodiments, the control circuit can cause the rotatable arm to rotate at a speed which is smooth by controlling rotational acceleration of the rotatable arm to be continuous (e.g., any step changes in acceleration of the rotatable arm are less than a threshold), and/or by controlling rotational speed of the rotatable arm to have a sinusoidal or other smooth profile. In some embodiments, the control circuit can control operation of a magnetic drive system to output pulses of magnetic force (e.g., magnetic fields) to control speed, amplitude, or other parameters of the motion of the rotatable arm. It will be appreciated that systems in accordance with the present disclosure may include features of both the motion control systems described with reference to FIGS. 11-13 and the magnetic drive systems described with reference to FIGS. 14-16.

These systems, in some examples, include sensor assemblies which detect various characteristics of the motion (e.g., rotational motion of the rotatable arm) and generate signals in accordance with the detected various characteristics of the motion. These signals are then sent to the programmable controller of the drive mechanisms such that the programmable controller adjusts the driving force or the driving torque delivered by the driving mechanism,

In some embodiments, the power device or system includes a motor (e.g., a direct current motor). In some embodiments, the power device or system includes a magnetic drive system. For example, the magnetic drive system may include an electromagnetic drive system configured to generate both attractive and repulsive magnetic forces with another magnetic component of the magnetic drive system to drive motion of the moving object. In some embodiments, the magnetic drive system includes a solenoid drive system including an electromagnetic coil and a magnetic component configured to fit within the coil and generate a magnetic force to drive motion of the moving object.

The driving mechanism for driving motion of the moving object also includes a control device or control circuit configured to detect or monitor various motion characteristics of the motion of the moving object. For example, the control device or control circuit can be configured to detect characteristics of translational motion of the moving object, such as translational speed or velocity as well as translational distance traveled. In some embodiments, the control device or control circuit is configured to detect characteristics of rotational motion of the moving object, such as at least one of rotational amplitude, rotational speed, or velocity. The control device and control circuit can be configured to generate control signals for controlling the driving force or driving torque based on the detected characteristics.

### DC Motor System

Referring to FIG. 12, a schematic of a controller system 1200 including a motor system 1205 and a control device 1210 for motion of a moving object 1215 is shown according to an embodiment of the present disclosure. As shown in FIG. 12, the system includes a motor 1220 (e.g., a DC motor), a velocity sensor system (e.g., speed sensor system) 1225, and a velocity control circuit (e.g., motor driving circuit) 1230. The DC motor 1220 is configured to provide a driving force or torque which is applied to the moving object 1215. According to an embodiment, the system includes a speed controller including a power supply 1235, the DC motor 1220, a speed-reducing system (e.g., transmission) 1240, a speed sensing system (e.g., speed sensor system 1225), and an electronic control unit (e.g., microcontroller 1245). The speed-reducing system 1240 can be configured to control the motor power to the moving object 1215, such as to mobilize the moving object 1215 in at least one of a first (e.g., fore) or second (e.g., aft) direction. In some embodiments, the speed reducing system 1240 includes a speed-reduction gear-set. In some embodiments, the speed setup circuit 1250 is configured to receive a speed value (e.g., from a user input) and cause the microcontroller 245 to control operation of the motor 1220 based on the speed value.

The speed sensor system 1225 can be configured to measure the speed (e.g., rotational speed of the moving object 1215) and output an electrical signal representative of the speed. For example, the speed sensor system 1225 can include an optical sensor and an encoder wheel. The optical sensor can include a light source and a photodiode. The output signal of the photodiode may correspond to the swing speed information, and this output signal can be input to the electronic control circuit 1245. The speed sensor system 1225 may include magnetic sensors.

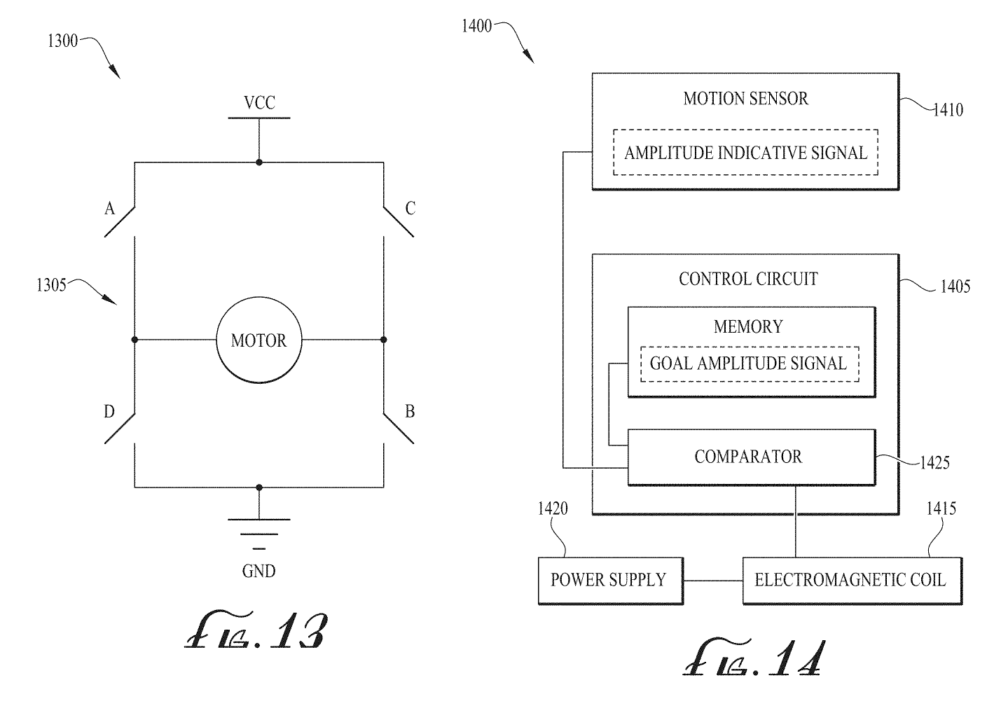

FIG. 13 illustrates a motor driving circuit 1300 according to an embodiment of the present disclosure. The motor driving circuit 1300 can be configured to interface with a DC motor (e.g., motor 1220). As shown in FIG. 13, the motor driving circuit 1300 may be implemented using an H-bridge circuit 405 to drive the DC motor 1220. Switches (e.g., switches A, B, C, and D as shown in FIG. 12) can be either open or closed, resulting in a total of sixteen possible switch settings. By controlling the switches on/off in different combinations, the DC motor can be driven forward or backward or allowed to freewheel to mobilize the moving object in accordance with the desired operation. The speed setup circuit 1250 of FIG. 12 can be configured to receive a user input indicating a desired speed for the moving object.

### Magnetic Drive Systems

Referring now to FIGS. 14-16, in various embodiments. Drive systems can be configured to control movement of movable objects, such as rotatable arms. The drive system can be configured to cause the movable object to move with constant amplitude (e.g., by outputting electromagnetic pulses configured to apply controlled forces to the movable object), which may improve upon existing systems (e.g., DC motor systems). For example, magnetic drive systems may provide superior reliability and operate quietly. In some embodiments, the drive system includes an electromagnetic drive system. In some embodiments, the drive system includes a solenoid drive system.

FIG. 14 is a schematic illustration of a magnetic drive system 1400 according to an embodiment of the present disclosure. The magnetic drive system includes control circuit 1405, motion sensor 1410, electromagnetic coil 1415, and power supply 1420. The control circuit 1405 may include a memory device for storing a goal amplitude, and a comparator circuit 1425 configured to compare a received amplitude signal to the goal amplitude to control operation of the electromagnetic coil 1415 based on the comparison. The power supply 1420 may include one or more batteries and/or may be connected to any suitable source of electric current (e.g., a plug-in AC/DC power supply). A direction of electric current supplied to the electromagnetic coil 1415 dictates its polarity and pulses of electric current are transmitted to the electromagnetic coil 1415. The pulses generate a magnetic force which repels the electromagnetic coil from a permanent magnet (not shown) which may be coupled to the movable object (e.g., moving object 1215). For example, by repeatedly transmitting electric current to the electromagnetic coil 1415 as it passes by the permanent magnet, a movable object can be driven along a predetermined motion path (e.g., a rotational motion path).

### Electromagnetic Drive System

In some embodiments, an electromagnetic drive system includes a first magnetic component including a permanent magnet positioned in any suitable location (e.g., within a medial portion of a support member of the moving object). The permanent magnet includes any suitable magnet, such as a ferrous magnet stacked vertically with a neodymium magnet. The electromagnetic drive system may also include a second magnetic component including an electromagnetic coil, which can be positioned within a housing connected to the moving object. In some embodiments, the electromagnetic coil includes a metal core (such as steel, iron, etc.) to strengthen a magnetic force generated by the electromagnetic coil. In some embodiments, the electromagnetic drive system also includes a control circuit. The control circuit can be configured to receive signals from a user input control and motion sensor. The control circuit can be configured to generate control signals which control a motion of the movable object.

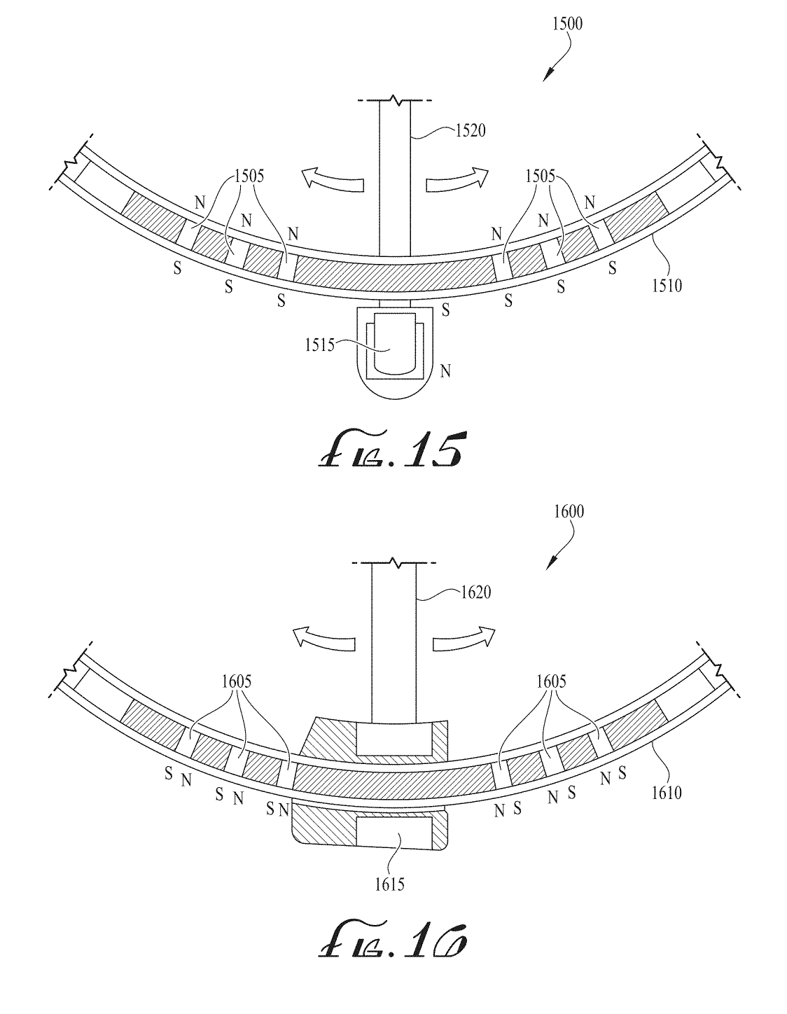

Referring now to FIG. 15, a cross-sectional side view of an electromagnetic drive system 1500 for driving a rotatable arm is shown according to an embodiment of the present disclosure. In some embodiments, the system includes a first magnetic component including two arrays of permanent magnets 1505 spaced apart within a support member 1510. Electromagnetic coil 1515 is operatively connected to the arm 1520, which is configured to rotate about a pivot point (not shown).

### Solenoid Drive System

In some embodiments, the drive system includes a solenoid drive system. Herein the term “solenoid” refers to a type of electromagnet including an electromagnetic coil configured to wrap around a movable core (e.g., a permanent magnet). In some embodiments, a solenoid drive system includes a first magnetic component and a second magnetic component configured to generate a magnetic force which drives motion of a movable object. The first magnetic component includes a permanent magnet positioned within or adjacent to a structure connected to the movable object. The second magnetic component includes an electromagnetic coil.

The permanent magnet includes one or more suitable magnets and may be secured to the structure connected to the movable object. For example, the permanent magnet can include several, smaller permanent magnets, which may be connected together. In some embodiments, the several, smaller permanent magnets are arranged in an arcuate shape substantially parallel to a curvature or shape of the structure connected to the movable object,

In some embodiments, the electromagnet is configured to generate a magnetic force with the permanent magnet when electric power is supplied to the electromagnet by a power supply. The power supply includes any suitable source of electric current (e.g., batteries, plug-in AC/DC power supply). The solenoid drive system can be configured to cause pulses of electric current to be transmitted to the electromagnetic coil by the power supply, such as to provide a driving force or torque on the movable object. The solenoid drive system can allow the movable object to be driven by the reaction of the permanent magnet to a concentrated magnetic field present within a cavity of the electromagnetic coil. In some such embodiments, the magnetic force generated by the pulses is relatively strong. Additionally, by applying the magnetic force generated by the first and the second magnetic components, the system can reduce a force necessary to drive the movable object. These properties of the solenoid drive system can increase an overall efficiency of the system by requiring less power to drive motion of the movable object.

The solenoid drive system also includes a control circuit. The control circuit can be configured to receive signals from a user input control and motion sensor. The control circuit can be configured to generate control signals which control a motion of the movable object. The control signals generated by the control circuit are configured to control at least one of a timing, direction, or width of an electric current transmitted from the power supply to the electromagnet coil, such as for controlling pulses of magnetic forces outputted by the electromagnetic coil.

Referring now to FIG. 16, a cross-sectional side view of a solenoid drive system 1600 for driving a rotatable arm is shown according to an embodiment of the present disclosure. The system includes a first magnetic component including two arrays of permanent magnets 1605 spaced apart within the support member 1610, which is connected to a movable object or to a structure supporting the movable object. The control circuit can be configured to produce a driving torque by pulsing an electromagnetic coil 1615 as it moves along the support member 1610 between the permanent magnets 1605 arrays. Based on signals received from a motion sensor (not shown), the control circuit can determine a direction of the electromagnetic coil 1615 and reverses its polarity as an amplitude of an arm 1620 peaks and a direction of rotational motion changes. Electromagnetic coil 1615 may be pulsed and driven by the magnetic forces generated between it and the permanent magnets 1605 across a full range of motion of the electromagnetic coil 1615.

While the invention has been described with reference to example embodiments, it will be understood by those skilled in the art that a variety of modifications, additions and deletions are within the scope of the invention, as defined by the following claims

What is claimed is:

1. A child support device comprising;
a support frame including:
a base portion:
an upright portion extending upwardly from the base portion, the upright portion being generally V-shaped and including an upper junction;
a handle formed with or attached to the upper junction to facilitate transporting the child support device;
two or more wheels attached to the base portion to facilitate movement of the base portion; and
wherein the support frame is narrow enough to fit through a 30-inch wide door opening;
at least one support arm pivotally suspended from the upper junction at a proximal end thereof;
a child-receiving receptacle pivotally coupled to the at least one support arm; and
a capacitive touch control panel adjacent the upper junction for controlling operation of the child support device in response to user touches indicating user inputs.

2. The child support device of claim 1, wherein the child-receiving receptacle is pivotally coupled to a distal end of the at least one support arm for pivotal movement about a generally vertical axis.

3. The child support device of claim 1, further comprising a drive mechanism for driving the movement of the at least one support arm and the child-receiving receptacle with respect to the support frame.

4. The child support device of claim 3, wherein the child support device is a swing.

5. The child support device of claim 1, wherein the child support device is a swing and the child-receiving receptacle is supported by a single support arm.

6. The child support device of claim 1, wherein base and upright portions of the support frame, when viewed from the side, are collectively generally S-shaped.

7. The child support device of claim 1, wherein the capacitive touch control panel includes a transparent overlay layer, a sensor layer, and a display layer.

8. The child support device of claim 7, wherein the capacitive touch control panel includes one or more components manufactured from a flexible substrate, and the capacitive touch control panel is positioned within the upper junction of the support base upright portion.

9. The child support device of claim 7, wherein the capacitive touch control panel can receive a user input, such as a touch, swipe, or other contact from a finger of a user, from a stylus, or any other object.

10. The child support device of claim 1, wherein the child support device is a swing and further comprising a drive mechanism for driving the movement of the at least one support arm and the child-receiving receptacle with respect to the support frame.

11. A child support device comprising;
a support frame including:
a base portion:
an upright portion extending upwardly from the base portion, the upright portion being generally V-shaped and including an upper junction;
a handle formed with or attached to the upper junction to facilitate transporting the child support device;
two or more wheels attached to the base portion to facilitate movement of the base portion; and
wherein the support frame is narrow enough to fit through a 30-inch wide door opening and wherein base and upright portions of the support frame, when viewed from the side, are collectively generally S-shaped:
at least one support arm pivotally suspended from the upper junction at a proximal end thereof; and
a child-receiving receptacle pivotally coupled to the at least one support arm.

12. The child support device of claim 11, wherein the child-receiving receptacle is pivotally coupled to a distal end of the at least one support arm for pivotal movement about a generally vertical axis.

13. The child support device of claim 11, further comprising a drive mechanism for driving the movement of the at least one support arm and the child-receiving receptacle with respect to the support frame.

14. The child support device of claim 13, wherein the child support device is a swing.

15. The child support device of claim 11, wherein the child support device is a swing and the child-receiving receptacle is supported by a single support arm.

16. The child support device of claim 13, further comprising a capacitive touch control panel adjacent the upper junction for controlling operation of the child support device in response to user touches indicating user inputs, the capacitive touch control panel including a transparent overlay layer, a sensor layer, and a display layer.

17. The child support device of claim 16, wherein the capacitive touch control panel includes one or more components manufactured from a flexible substrate, and the capacitive touch control panel is positioned within the upper junction of the support base upright portion.

18. The child support device of claim 16, wherein the capacitive touch control panel can receive a user input, such as a touch, swipe, or other contact from a finger of a user, from a stylus, or any other object.

19. The child support device of claim 11, wherein the child support device is a swing and further comprising a drive mechanism for driving the movement of the at least one support arm and the child-receiving receptacle with respect to the support frame.

20. A child support device comprising:
a support frame including a loop-like base, a generally V-shaped upright portion extending from the loop-like base and having an upper junction, a handle adjacent the upper junction, and at least two wheels coupled to the loop-like base to facilitate transporting the child support device;
a swing arm rotatably coupled to the support frame adjacent the upper junction for pivotal movement with respect to the support frame;
a child-receiving receptacle rotatably coupled to the swing arm for pivotal motion about a generally upright axis; and
a drive mechanism for driving the pivotal movement of he swing arm with respect to the support frame.
